(19) United States
(12) Patent Application Publication
(10) Pub. No.: US 2026/0100159 A1
(43) Pub. Date: Apr. 9, 2026

(54) DISPLAY DEVICE SUPPORTING A VARIABLE FRAME MODE AND ELECTRONIC DEVICE INCLUDING THE SAME

(71) Applicant: Samsung Display Co., LTD., Yongin-si (KR)

(72) Inventors: JUNG-TAEK KIM, Yongin-si (KR); HONG-KYU KIM, Yongin-si (KR)

(21) Appl. No.: 19/236,311

(22) Filed: Jun. 12, 2025

(30) Foreign Application Priority Data
Oct. 8, 2024 (KR) 10-2024-0137052

(51) Int. Cl. G09G 3/3233; G09G 3/3266; G09G 3/3275

(52) U.S. Cl. CPC G09G 3/3233; G09G 3/3266; G09G 3/3275; G09G 2300/0819; G09G 2300/0842; G09G 2310/08; G09G 2320/02; G09G 2340/0435

(57) ABSTRACT

A display device includes a display panel including a plurality of pixels, and a panel driver which drives the display panel based on input image data. In a variable frame mode in which the panel driver receives the input image data at a variable frame frequency, the panel driver selectively performs a data compensation operation or an initialization compensation operation based on a luminance of the display panel and a frequency change amount of the variable frame frequency.

This application claims priority to Korean Patent Application No. 10-2024-0137052, filed on Oct. 8, 2024, and all the benefits accruing therefrom under 35 U.S.C. § 119, the content of which in its entirety is herein incorporated by reference.

### BACKGROUND

### 1. Field

Embodiments relate generally to display devices, and more particularly to a display device supporting a variable frame mode, and an electronic device including the display device.

### 2. Description of the Related Art

In general, a display device may display an image at a constant frame frequency (or a constant frame rate) of about 60 Hz, about 120 Hz, about 240 Hz, or the like. However, a frame frequency of rendering by a processor (e.g., a graphics processing unit (GPU), an application processor (AP) or a graphics card) that provides frame data to the display device may be different from the frame frequency of the display device. For example, when the processor provides the display device with frame data for a game image (gaming image) that requires complicated rendering, the frame frequency mismatch may be intensified. In this case, a tearing phenomenon may occur where a boundary line is caused by the frame frequency mismatch in an image of the display device.

To prevent or reduce the tearing phenomenon, a variable frame mode (e.g., Free-Sync, G-Sync, etc.) has been developed in which a processor provides frame data to a display device at a variable frame frequency by changing a time (or a duration of time) of a blank period in each frame period. A display device supporting the variable frame mode may display an image in synchronization with the variable frame frequency, thereby substantially reducing or effectively preventing the tearing phenomenon.

### SUMMARY

Some embodiments provide a display device capable of reducing a luminance deviation caused by a frame frequency change.

Some embodiments provide an electronic device including a display device capable of reducing a luminance deviation caused by a frame frequency change.

According to embodiments, a display device includes a display panel including a plurality of pixels, and a panel driver which drives the display panel based on input image data. In such embodiments, in a variable frame mode in which the panel driver receives the input image data at a variable frame frequency, the panel driver selectively performs a data compensation operation or an initialization compensation operation based on a luminance of the display panel and a frequency change amount of the variable frame frequency.

In embodiments, the panel driver may perform the data compensation operation by adjusting voltage levels of data voltages provided to the plurality of pixels in an active period of a frame period according to the variable frame frequency.

In embodiments, as the variable frame frequency decreases, the panel driver may decrease the voltage levels of the data voltages.

In embodiments, the panel driver may perform the initialization compensation operation by performing a dummy scan operation for initializing light emitting elements of the plurality of pixels in a blank period of a frame period.

In embodiments, the panel driver may perform the data compensation operation when the luminance of the display panel is greater than or equal to a reference luminance or the frequency change amount of the variable frame frequency is less than or equal to a reference frequency change amount, and may perform the initialization compensation operation when the luminance of the display panel is less than the reference luminance and the frequency change amount of the variable frame frequency is greater than the reference frequency change amount.

In embodiments, the panel driver may output first blank data voltages in a blank period of a first frame period in which the data compensation operation is performed, and may output second blank data voltages, which are different from the first blank data voltages, in a blank period of a second frame period in which the initialization compensation operation is performed.

In embodiments, the second blank data voltages may be higher than the first blank data voltages.

In embodiments, the panel driver may include a scan driver which provides first scan signals and second scan signals to the plurality of pixels in an active period of a frame period, a data driver which provides data voltages to the plurality of pixels in the active period, and a controller which controls the scan driver and the data driver. In such embodiments, the controller may include a display luminance determining block which determine the luminance of the display panel based on the input image data, a frequency change amount determining block which determines the frequency change amount of the variable frame frequency based on a vertical synchronization signal, and a compensation operation selecting block which selects the data compensation operation or the initialization compensation operation based on the luminance of the display panel and the frequency change amount of the variable frame frequency.

In embodiments, the compensation operation selecting block may select the data compensation operation when the luminance of the display panel is greater than or equal to a reference luminance or the frequency change amount of the variable frame frequency is less than or equal to a reference frequency change amount, and may select the initialization compensation operation when the luminance of the display panel is less than the reference luminance and the frequency change amount of the variable frame frequency is greater than the reference frequency change amount.

In embodiments, when the compensation operation selecting block selects the data compensation operation, the data driver may decrease voltage levels of the data voltages as the variable frame frequency decreases.

In embodiments, when the compensation operation selecting block selects the initialization compensation operation, the scan driver may perform a dummy scan operation by sequentially providing the second scan signals to the plurality of pixels in a blank period of the frame period.

In embodiments, in a blank period of a first frame period in which the compensation operation selecting block selects the data compensation operation, the data driver may output first blank data voltages to a plurality of data lines of the display panel. In such embodiments, in a blank period of a second frame period in which the compensation operation selecting block selects the initialization compensation operation, the data driver may output second blank data voltages, which are different from the first blank data voltages, to the plurality of data lines.

In embodiments, the first blank data voltages may be minimum data voltages corresponding to a minimum gray level.

In embodiments, the first blank data voltages may be lower than a minimum data voltage corresponding to a minimum gray level.

In embodiments, the second blank data voltages may be equal to the data voltages provided to a last pixel row of the display panel in an active period of the second frame period.

In embodiments, the second blank data voltages may be boosted voltages which are increased from the data voltages provided to a last pixel row of the display panel in an active period of the second frame period.

In embodiments, the second blank data voltages may be an initialization voltage.

In embodiments, a blank period of the frame period may include a sensing period and a recovery period, and the panel driver may further include a sensing circuit which performs a sensing operation on selected pixels among the plurality of pixels in the sensing period.

In embodiments, in the sensing period, the data driver may output sensing data voltages to data lines which are connected to the selected pixels among a plurality of data lines of the display panel, and may output first blank data voltages to data lines which are not connected to the selected pixels among the plurality of data lines. In such embodiments, in the recovery period, the data driver may output recovery data voltages equal to the data voltages provided in the active period to the plurality of data lines.

In embodiments, within a blank period of a first frame period in which the compensation operation selecting block selects the data compensation operation, the data driver outputs the first blank data voltages to the plurality of data lines after the recovery period. In such embodiment, within a blank period of a second frame period in which the compensation operation selecting block selects the initialization compensation operation, the data driver may output second blank data voltages, which are different from the first blank data voltages, to the plurality of data lines after the recovery period.

In embodiments, the second blank data voltages may be equal to the recovery data voltages output in the recovery period of the second frame period.

In embodiments, the second blank data voltages may be boosted voltages which are increased from the recovery data voltages output in the recovery period of the second frame period.

According to embodiments, a display device includes a display panel including a plurality of pixels, and a panel driver which drives the display panel based on input image data. In such embodiments, in a variable frame mode in which the panel driver receives the input image data at a variable frame frequency, the panel driver selectively performs a data compensation operation or an initialization compensation operation based on a luminance of the display panel and a frequency change amount of the variable frame frequency. In such embodiments, the panel driver outputs first blank data voltages in a blank period of a first frame period in which the data compensation operation is performed, and outputs second blank data voltages, which are different from the first blank data voltages, in a blank period of a second frame period in which the initialization compensation operation is performed.

According to embodiments, an electronic device includes a processor which provide input image data at a variable frame frequency in a variable frame mode, and a display device including a display panel including a plurality of pixels, and a panel driver which drives the display panel based on the input image data. In such embodiments, in the variable frame mode, the panel driver selectively performs a data compensation operation or an initialization compensation operation based on a luminance of the display panel and a frequency change amount of the variable frame frequency.

In embodiments, the panel driver may output first blank data voltages in a blank period of a first frame period in which the data compensation operation is performed, and may output second blank data voltages, which are different from the first blank data voltages, in a blank period of a second frame period in which the initialization compensation operation is performed.

As described above, in a display device and an electronic device according to embodiments, in a variable frame mode, a data compensation operation or an initialization compensation operation may be selectively performed based on a luminance of a display panel and a frequency change amount of a variable frame frequency. Accordingly, a luminance deviation caused by a frame frequency change may be substantially reduced.

Further, in the display device and the electronic device according to embodiments, first blank data voltages may be output in a blank period of a first frame period in which the data compensation operation is performed, and second blank data voltages, which are different from (e.g., higher than) the first blank data voltages, may be output in a blank period of a second frame period in which the initialization compensation operation is performed. Accordingly, the luminance deviation caused by the frame frequency change may be further reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a circuit diagram illustrating an example of a pixel included in a display device according to embodiments.

FIG. 3A is a signal timing diagram illustrating an example of input image data input to a display device at a variable frame frequency, FIG. 3B is a diagram illustrating an example of luminances of a display panel at different frame frequencies in a conventional display device, and FIG. 3C is a diagram illustrating an example of a luminance according to a variable frame frequency in the conventional display device.

FIG. 4 is a block diagram illustrating a controller included in a display device according to embodiments.

FIG. 5 is a flowchart illustrating a method of operating a display device according to embodiments.

FIG. 6A is a diagram illustrating examples of data voltages according to a gray level at a minimum frame frequency and a maximum frame frequency in a case where a data compensation operation is performed, FIG. 6B is a signal timing diagram for describing an example of the data compensation operation, and FIG. 6C is a diagram illustrating an example of a luminance according to a variable frame frequency in the case where the data compensation operation is performed.

FIG. 7A is a signal timing diagram for describing an example of an initialization compensation operation, FIG. 7B is a diagram illustrating an example of luminances at different frame frequencies in a case where the initialization compensation operation is performed, FIG. 7C is a signal timing diagram for describing another example of the initialization compensation operation, and FIG. 7D is a diagram illustrating an example of a luminance according to a variable frame frequency in the case where the initialization compensation operation is performed.

FIG. 8 is a diagram illustrating examples of luminance deviations according to a variable frame frequency with respect to a first luminance and a second luminance in a case where a data compensation operation is performed and a case where an initialization compensation operation is performed.

FIG. 9 is a flowchart illustrating a method of operating a display device according to embodiments.

FIG. 10 is a signal timing diagram for describing a first blank data voltage that is output in a first blank period of a first frame period in which a data compensation operation is performed and a second blank data voltage that is output in a second blank period of a second frame period in which an initialization compensation operation is performed.

FIG. 11A is a diagram illustrating an example of a luminance according to a variable frame frequency in a case where a data compensation operation is performed, and FIG. 11B is a diagram illustrating an example of a luminance according to a variable frame frequency in a case where an initialization compensation operation is performed.

FIG. 12 is a block diagram illustrating a display device according to embodiments.

FIG. 13 is a signal timing diagram for describing a first blank data voltage that is output in a first blank period of a first frame period in which a data compensation operation is performed and a second blank data voltage that is output in a second blank period of a second frame period in which an initialization compensation operation is performed.

FIG. 14 is a block diagram illustrating an electronic device including a display device according to embodiments.

FIG. 15 is a block diagram illustrating an example of an electronic device according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Embodiments will be described more fully hereinafter with reference to the accompanying drawings. Like or similar reference numerals refer to like or similar elements throughout.

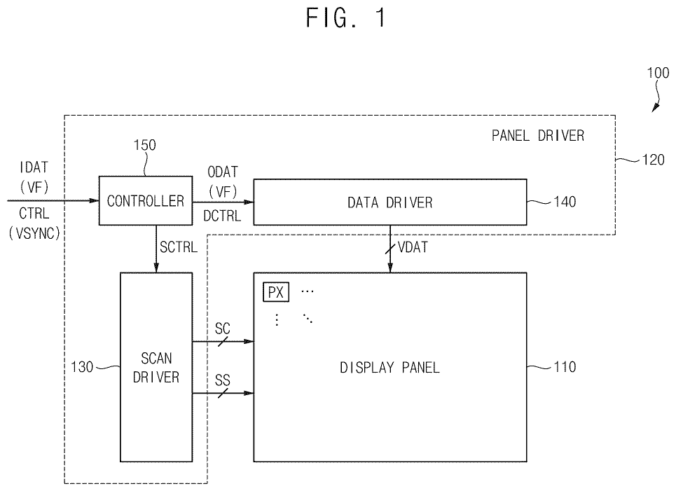

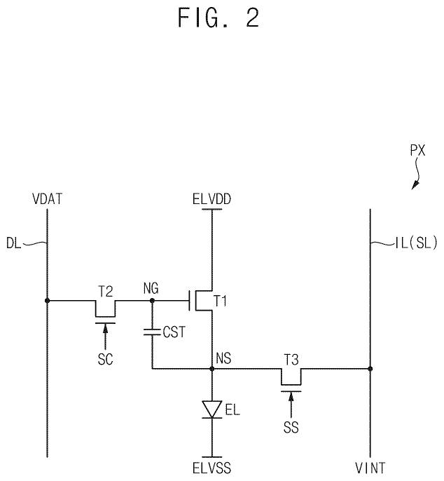

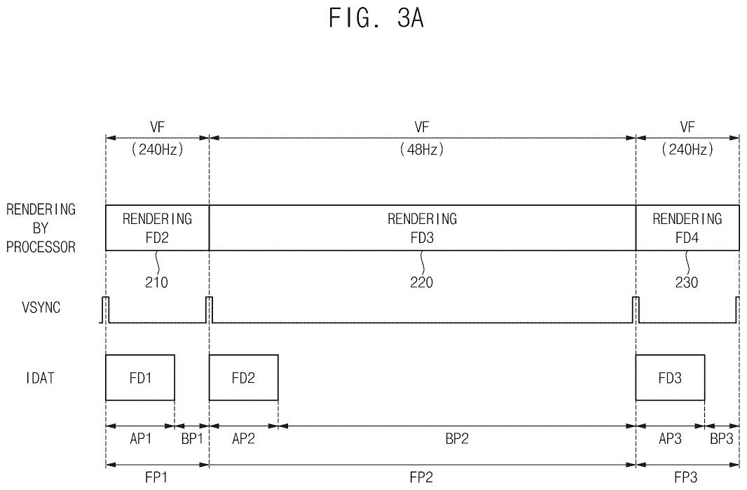

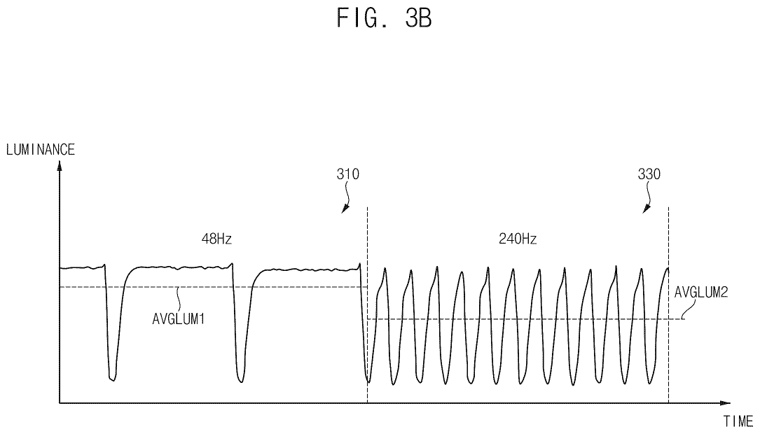

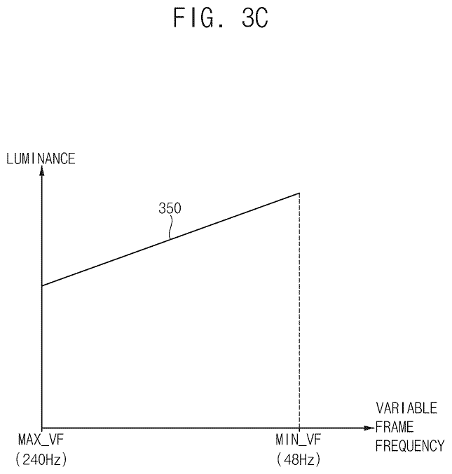

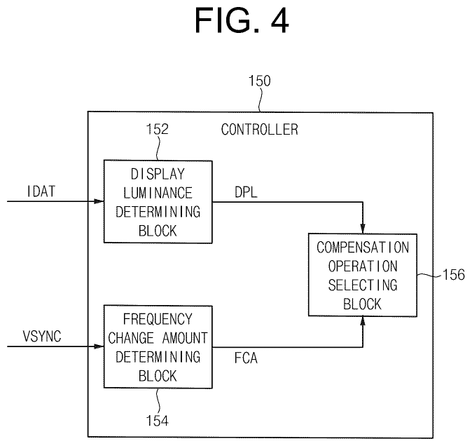

FIG. 1 is a block diagram illustrating a display device according to embodiments, FIG. 2 is a circuit diagram illustrating an example of a pixel included in a display device according to embodiments, FIG. 3A is a signal timing diagram illustrating an example of input image data input to a display device at a variable frame frequency, FIG. 3B is a diagram illustrating an example of luminances of a display panel at different frame frequencies in a conventional display device, FIG. 3C is a diagram illustrating an example of a luminance according to a variable frame frequency in the conventional display device, and FIG. 4 is a block diagram illustrating a controller included in a display device according to embodiments.

Referring to FIG. 1, a display device 100 according to embodiments may include a display panel 110 that includes a plurality of pixels PX, and a panel driver 120 that drives the display panel 110. In some embodiments, the panel driver 120 may include a scan driver 130 that provides first scan signals SC and second scan signals SS to the plurality of pixels PX, a data driver 140 that provides data voltages VDAT to the plurality of pixels PX, and a controller 150 that controls the scan driver 130 and the data driver 140.

The display panel 110 may include a plurality of data lines, a plurality of initialization lines (or a plurality of sensing lines), and the plurality of pixels PX connected to the plurality of data lines and the plurality of initialization lines. In some embodiments, each pixel PX may include a light emitting element, and the display panel 110 may be a light emitting display panel.

In an embodiment, for example, as illustrated in FIG. 2, each pixel PX may have a three transistor-one capacitor (“3T1C”) structure including a first transistor T1, a second transistor T2, a third transistor T3, a capacitor CST and a light emitting element EL, but not being limited thereto.

The capacitor CST may store the data voltage VDAT transferred by the second transistor T2 from the data line DL. The capacitor CST may be referred to as, but not limited to, a storage capacitor for storing the data voltage VDAT. In some embodiments, the capacitor CST may include a first electrode connected to a first node NG (e.g., a gate node) and a second electrode connected to a second node NS (e.g., a source node).

The first transistor T1 may generate a driving current based on the data voltage VDAT stored in the capacitor CST. The first transistor T1 may be referred to as, but not limited to, a driving transistor for generating the driving current. In some embodiments, the first transistor T1 may include a gate connected to the first node NG, a first terminal (e.g., a drain) which receives a first power supply voltage ELVDD (e.g., a high power supply voltage), and a second terminal (e.g., a source) connected to the second node NS.

The second transistor T2 may transfer the data voltage VDAT from the data line DL to the first node NG in response to the first scan signal SC. The second transistor T2 may be referred to as, but not limited to, a scan transistor. In some embodiments, the second transistor T2 may include a gate which receives the first scan signal SC, a first terminal connected to the data line DL, and a second terminal connected to the first node NG.

The third transistor T3 may transfer an initialization voltage VINT from the initialization line IL to the second node NS in response to the second scan signal SS. When the initialization voltage VINT is applied to the second node NS, the light emitting element EL may be initialized or turned off based on the initialization voltage VINT. In some embodiments, the initialization line IL may be used as a line for initializing the light emitting element EL as well as a sensing line SL for sensing a characteristic of the pixel PX. Further, in some embodiments, the second scan signal SS may be referred to as, but not limited to, a sensing signal, and the third transistor T3 may be referred to as, but not limited to, a sensing transistor. In some embodiments, the third transistor T3 may include a gate which receives the second scan signal SS, a first terminal connected to the second node NS, and a second terminal connected to the initialization line IL.

The light emitting element EL may emit light in response to the driving current generated by the first transistor T1. In some embodiments, the light emitting element EL may include an anode connected to the second node NS, and a cathode which receives a second power supply voltage ELVSS (e.g., a low power supply voltage). In some embodiments, the light emitting element EL may be an organic light emitting diode (“OLED”). In other embodiments, the light emitting element EL may be a micro light emitting diode, a nano light emitting diode (“NED”), a quantum dot (“QD”) light emitting diode, an inorganic light emitting diode, or any other suitable light emitting element.

In some embodiments, as illustrated in FIG. 2, the first, second and third transistors T1, T2 and T3 may be implemented as, but not limited to, N-type metal oxide semiconductor (“NMOS”) transistors. Although FIG. 2 illustrates an embodiment of the pixel PX having the 3T1C structure, the pixel PX according to embodiments is not limited to the example of FIG. 2.

Referring back to FIG. 1, the scan driver 130 may generate the first scan signals SC and the second scan signals SS based on a scan control signal SCTRL received from the controller 150, and may sequentially provide the first scan signals SC and the second scan signals SS to the plurality of pixels PX on a row-by-row basis in an active period of each frame period. In some embodiments, the scan control signal SCTRL may include, but is not limited to, a scan start signal and a scan clock signal. In some embodiments, the scan driver 130 may be integrated or formed in the display panel 110. In other embodiments, the scan driver 130 may be implemented with one or more integrated circuits.

The data driver 140 may generate the data voltages VDAT based on a data control signal DCTRL and output image data ODAT received from the controller 150, and may provide the data voltages VDAT to the plurality of pixels PX through the plurality of data lines DL in the active period of each frame period. In some embodiments, the data control signal DCTRL may include, but is not limited to, an output data enable signal, a horizontal start signal and a load signal. Further, in some embodiments, the data driver 140 may receive the output image data ODAT from the controller 150 at a variable frame frequency VF that is variable within a variable frame frequency range (e.g., from about 48 Hz to about 240 Hz). In some embodiments, the data driver 140 and the controller 150 may be implemented as a single integrated circuit, and the single integrated circuit may be referred to as a signal timing controller embedded data driver (“TED”) integrated circuit. In other embodiments, the data driver 140 and the controller 150 may be implemented as separate integrated circuits.

The controller 150 (e.g., a timing controller) may receive input image data IDAT and a control signal CTRL from an external processor (e.g., a graphics processing unit (“GPU”), an application processor (“AP”) or a graphics card). In some embodiments, the input image data IDAT may be RGB image data including red image data, green image data and blue image data. Further, the control signal CTRL may include a vertical synchronization signal VSYNC that defines a start time point and/or an end time point of each frame period. In some embodiments, the control signal CTRL may further include, but is not limited to, a horizontal synchronization signal, an input data enable signal, a master clock signal, etc. The controller 150 may generate the scan control signal SCTRL, the data control signal DCTRL and the output image data ODAT based on the control signal CTRL and the input image data IDAT. The controller 150 may control an operation of the scan driver 130 by providing the scan control signal SCTRL to the scan driver 130, and may control an operation of the data driver 140 by providing the output image data ODAT and the data control signal DCTRL to the data driver 140.

The processor may provide the input image data IDAT to the display device 100 at a variable frame frequency VF (or a variable refresh rate) by changing a time length of a blank period in each frame period, and the controller 160 may receive the input image data IDAT from the processor at the variable frame frequency VF. In an embodiment, for example, the variable frame frequency VF may be varied in a range of, but not limited to, about 48 Hz to about 240 Hz. Further, the panel driver 120 may drive the display panel 110 at the variable frame frequency VF. That is, the controller 150 may control the scan driver 130 and the data driver 140 to drive the display panel 110 at the variable frame frequency VF. In some embodiments, a mode of the display device 100 in which the panel driver 120 may drive the display panel 110 at the variable frame frequency VF (or the variable refresh rate) may be referred to as a variable frame mode. In an embodiment, for example, the variable frame mode may be, but is not limited to, a Free-Sync mode, a G-Sync mode, etc.

In an embodiment, for example, as illustrated in FIG. 3A, a period or a frequency of renderings 210, 220 and 230 by the processor (e.g., the GPU, the AP or the graphics card) may not be constant, and the processor may provide the input image data IDAT, or frame data FD1, FD2 and FD3 to the display device 100 in synchronization with these irregular periods or frequencies of the renderings 210, 220 and 230 in the variable frame mode. Thus, in the variable frame mode, each frame period FP1, FP2 and FP3 may include an active period AP1, AP2 and AP3 having a constant time length and a blank period BP1, BP2 and BP3 having a variable time length. Here, each active period AP1, AP2 and AP3 may be a period in which the data voltages VDAT are sequentially written on a row-by-row basis or stored in the plurality of pixels PX of the display panel 110, and each blank period (e.g., BP1) may be a period between adjacent active periods (e.g., AP1 and AP2).

In an embodiment, as shown in FIG. 3A, when a rendering 210 for second frame data FD2 is performed at a frequency of about 240 Hz in a first frame period FP1, the processor may provide first frame data FD1 to the display device 100 at the variable frame frequency VF of about 240 Hz in the first frame period FP1. In a second frame period FP2, when a rendering 220 for third frame data FD3 is performed at a frequency of about 48 Hz, the processor may provide the second frame data FD2 to the display device 100 at the variable frame frequency VF of about 48 Hz by increasing a time length of the blank period BP2 of the second frame period FP2. In a third frame period FP3, when a rendering 230 for fourth frame data FD4 is performed again at a frequency of about 240 Hz, the processor may provide the third frame data FD3 to the display device 100 again at the variable frame frequency VF of about 240 Hz.

A conventional display device that operates in the variable frame mode may have different luminance at different variable frame frequencies VF. That is, in the conventional display device, each pixel PX may receive the second scan signal SS only once in each frame period FP1, FP2 and FP3, and the light emitting element EL of each pixel PX may be initialized or turned off only once in each frame period FP1, FP2 and FP3. Thus, as the variable frame frequency VF decreases, the number of times the light emitting element EL of each pixel PX is turned off for a certain period of time may be decreased, and the luminance of the conventional display device may be increased. For example, as illustrated in FIG. 3B, in the conventional display device, during a same time period, the number of times each light emitting element EL is turned off at the variable frame frequency VF of about 48 Hz may be less than the number of times each light emitting element EL is turned off at the variable frame frequency VF of about 240 Hz. Thus, an average AVGLUM1 of a luminance 310 of the conventional display device at the variable frame frequency VF of about 48 Hz may be higher than an average AVGLUM2 of a luminance 330 of the conventional display device at the variable frame frequency VF of about 240 Hz. Accordingly, as illustrated in FIG. 3C, a luminance 350 of the conventional display device may gradually decrease as the variable frame frequency VF decreases from a maximum frame frequency MAX_VF (e.g., about 240 Hz) to a minimum frame frequency MIN_VF (e.g., about 48 Hz). Thus, the conventional display device may have a luminance deviation (or a luminance change) when the variable frame frequency VF is changed.

To reduce the luminance deviation (or the luminance change) when the variable frame frequency VF is changed in the variable frame mode, the panel driver 120 of the display device 100 according to embodiments may selectively perform a data compensation operation or an initialization compensation operation based on a luminance of the display panel 110 and a frequency change amount of the variable frame frequency VF. In some embodiments, the panel driver 120 may perform the data compensation operation when the luminance of the display panel 110 is greater than or equal to a reference luminance or when the frequency change amount of the variable frame frequency VF is less than or equal to a reference frequency change amount. Further, the panel driver 120 may perform the initialization compensation operation when the luminance of the display panel 110 is less than the reference luminance and the frequency change amount of the variable frame frequency VF is greater than the reference frequency change amount. In some embodiments, to perform these operations, as illustrated in FIG. 4, the controller 150 of the panel driver 120 may include a display luminance determining block 152, a frequency change amount determining block 154 and a compensation operation selecting block 156.

The display luminance determining block 152 may determine the luminance DPL of the display panel 110 based on the input image data IDAT. In an embodiment, for example, the display luminance determining block 152 may calculate an average gray level of a plurality of gray levels represented by the input image data IDAT for the plurality of pixels PX of the display panel 110, and may determine the luminance DPL of the display panel 110 based on, but not limited to, the average gray level.

The frequency change amount determining block 154 may determine the frequency change amount FCA of the variable frame frequency VF based on the vertical synchronization signal VSYNC that defines a start time point and/or an end time point of each frame period. In an embodiment, for example, the frequency change amount determining block 154 may count a time interval between adjacent pulses of the vertical synchronization signal VSYNC, may determine a frame frequency of each frame period based on the counted time interval, and may determine the frequency change amount FCA based on a difference between frame frequencies of a previous frame period and a current frame period.

The compensation operation selecting block 156 may select the data compensation operation or the initialization compensation operation according to the luminance DPL of the display panel 110 determined by the display luminance determining block 152 and the frequency change amount FCA of the variable frame frequency VF determined by the frequency change amount determining block 154. In some embodiments, when the luminance DPL of the display panel 110 is greater than or equal to the reference luminance or when the frequency change amount FCA of the variable frame frequency VF is less than or equal to the reference frequency change amount, the compensation operation selecting block 156 may select the data compensation operation. Alternatively, when the luminance DPL of the display panel 110 is less than the reference luminance and the frequency change amount FCA of the variable frame frequency VF is greater than the reference frequency change amount, the compensation operation selecting block 156 may select the initialization compensation operation.

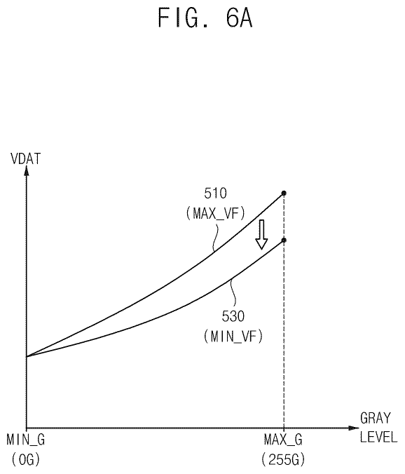

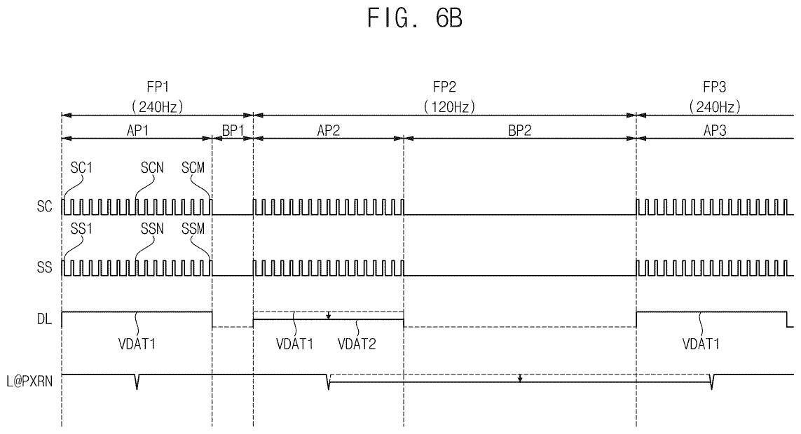

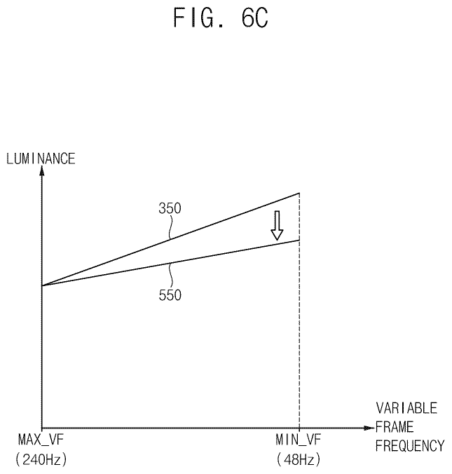

In some embodiments, when the data compensation operation is selected by the compensation operation selecting block 156, to perform the data compensation operation, the panel driver 120 (or the data driver 140) may adjust voltage levels of the data voltages VDAT provided to the plurality of pixels PX in an active period of a frame period based on the variable frame frequency VF. In an embodiment, for example, as described below with reference to FIGS. 6A through 6C, to perform the data compensation operation, the panel driver 120 (or the data driver 140) may decrease the voltage levels of the data voltages VDAT as the variable frame frequency VF decreases. By this data compensation operation, the luminance deviation (e.g., a luminance increase) caused by the decrease of the variable frame frequency VF may be reduced.

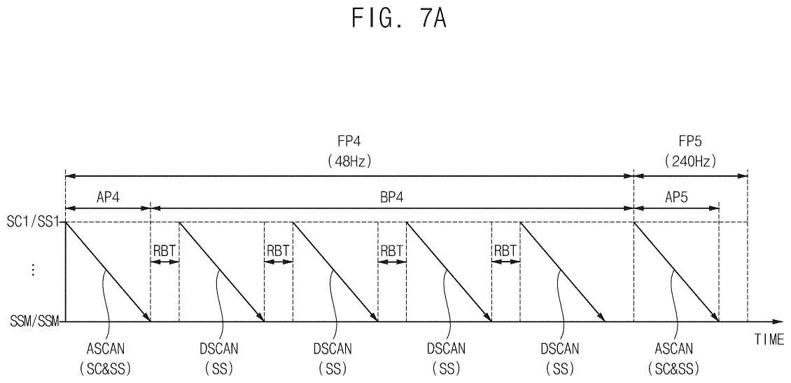

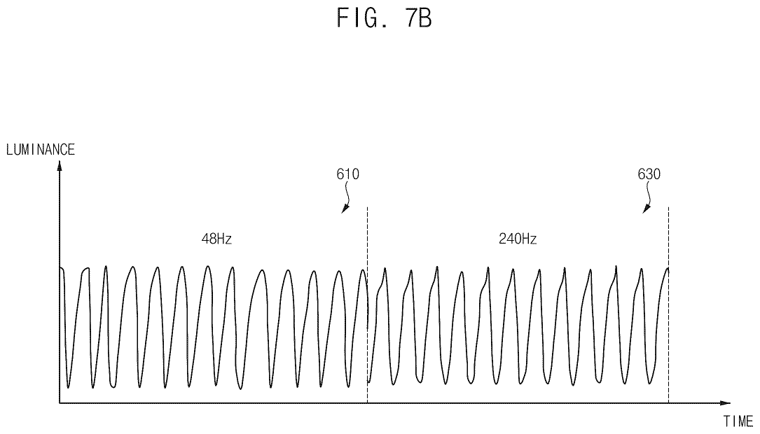

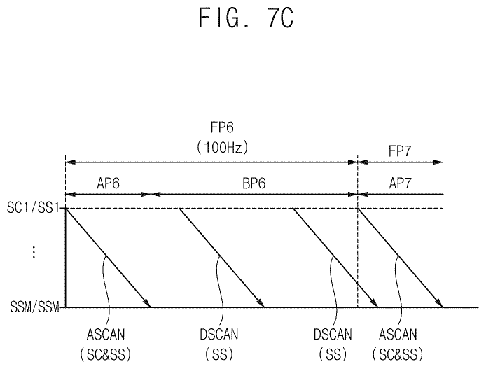

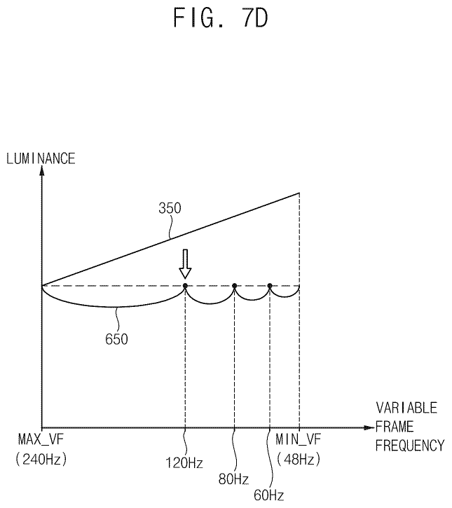

In embodiments, when the initialization compensation operation is selected by the compensation operation selecting block 156, to perform the initialization compensation operation, the panel driver 120 (or the scan driver 130) may perform not only an active scan operation that sequentially provides the first scan signals SC and the second scan signals SS to the plurality of pixels PX on a row-by-row basis in an active period of a frame period such that the data voltages VDAT are written to the plurality of pixels PX and the light emitting elements EL of the plurality of pixels PX are initialized, but also a dummy scan operation that sequentially provides only the second scan signals SS only the second scan signals SS in a blank period of the frame period such that the light emitting elements EL of the plurality of pixels PX are initialized. In an embodiment, for example, as described below with reference to FIGS. 7A through 7D, to perform the initialization compensation operation, the panel driver 120 (or the scan driver 130) may additionally and periodically perform the dummy scan operation that sequentially provides only the second scan signals SS to the plurality of pixels PX on the row-by-row basis in the blank period of the frame period. By this initialization compensation operation, the luminance deviation caused by a change of the variable frame frequency VF may be reduced.

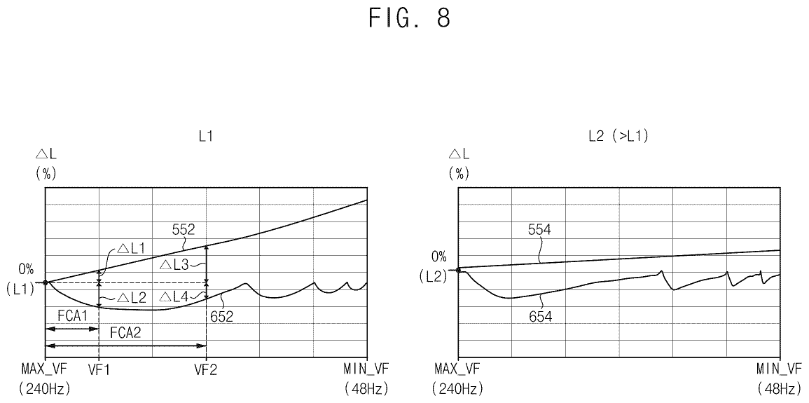

As described below with reference to FIG. 8, when the display panel 110 displays an image with a relatively high luminance (e.g., a luminance higher than the reference luminance), the luminance deviation of the display panel 110 caused by the change of the variable frame frequency VF when the data compensation operation is performed may be less than the luminance deviation of the display panel 110 caused by the change of the variable frame frequency VF when the initialization compensation operation is performed. Further, when the frequency change amount FCA of the variable frame frequency VF is relatively small (e.g., when the frequency change amount FCA is less than the reference frequency change amount), the luminance deviation of the display panel 110 caused by the change of the variable frame frequency VF when the data compensation operation is performed may be smaller than the luminance deviation of the display panel 110 caused by the change of the variable frame frequency VF when the initialization compensation operation is performed. Thus, in the display device 100 according to embodiments, the panel driver 120 may perform the data compensation operation when the luminance DPL of the display panel 110 is greater than or equal to the reference luminance or when the frequency change amount FCA of the variable frame frequency VF is less than or equal to the reference frequency change amount, and may perform the initialization compensation operation when the luminance DPL of the display panel 110 is less than the reference luminance and the frequency change amount FCA of the variable frame frequency VF is greater than the reference frequency change amount, thereby further reducing or minimizing the luminance deviation (or the luminance change) caused by the change of the variable frame frequency VF.

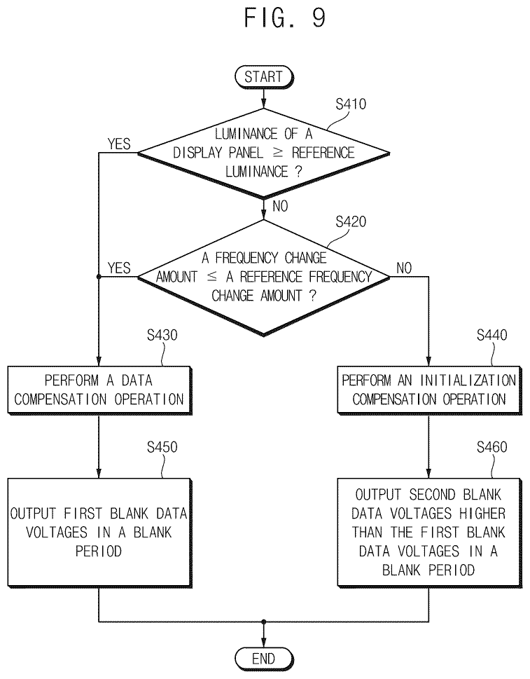

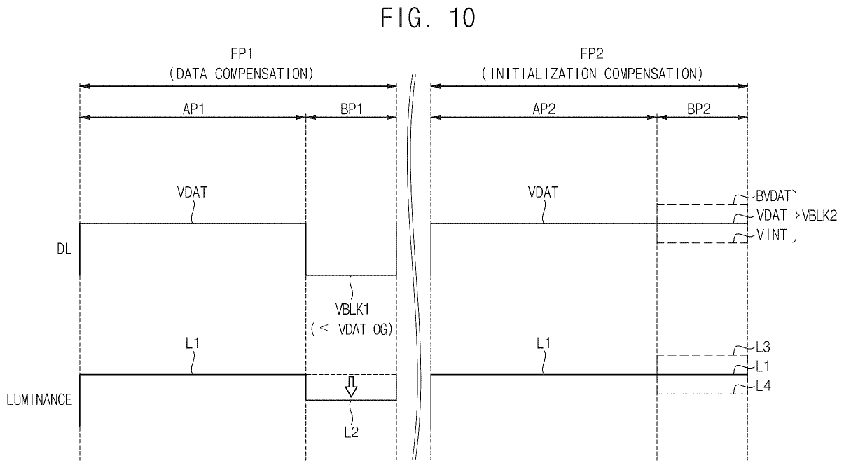

Further, in some embodiments, as described below with reference to FIGS. 9 and 10, the panel driver 120 may output first blank data voltages to the plurality of data lines DL in a blank period of a first frame period in which the data compensation operation is performed, and may output second blank data voltages, which are different from the first blank data voltages, to the plurality of data lines DL in a blank period of a second frame period in which the initialization compensation operation is performed. In some embodiments, the second blank data voltages may be higher than the first blank data voltages.

In some embodiments, in the blank period of the first frame period in which the compensation operation selecting block 156 selects the data compensation operation, the data driver 140 may output, as the first blank data voltages, the lowest voltage that can be output by the data driver 140 to the plurality of data lines DL of the display panel 110. In an embodiment, for example, the first blank data voltages may be the minimum data voltage corresponding to the minimum gray level (e.g., a 0-gray level), or may be lower than the minimum data voltage corresponding to the minimum gray level. Further, in some embodiments, in the blank period of the second frame period in which the compensation operation selecting block 156 selects the initialization compensation operation, the data driver 140 may output the second blank data voltages higher than the first blank data voltages to the plurality of data lines DL. In an embodiment, for example, the second blank data voltages may be substantially equal to the data voltages VDAT that were provided the plurality of pixels PX (e.g., the data voltages VDAT that were provided to the last pixel row of the display panel 110) in the active period of the second frame period. In another example, the second blank data voltages may be the initialization voltage VINT.

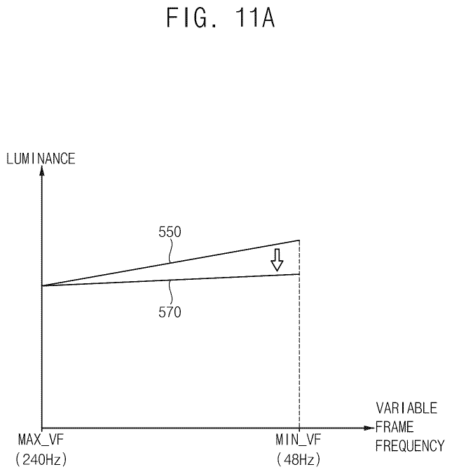

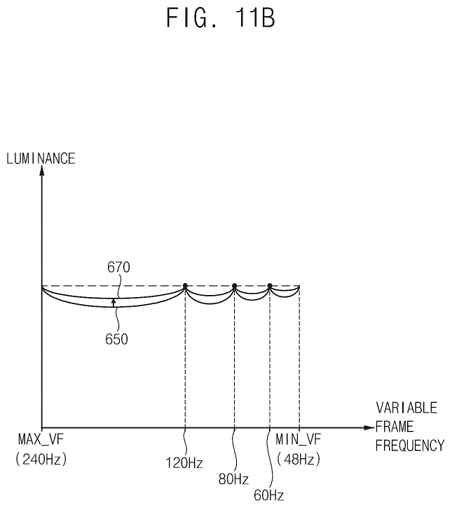

As described above, in the display device 100 according to embodiments, the data compensation operation or the initialization compensation operation may be selectively performed based on the luminance DPL of the display panel 110 and the frequency change amount FCA of the variable frame frequency VF. Accordingly, the luminance deviation (or the luminance change) caused by the change of the variable frame frequency VF may be reduced. Further, in the display device 100 according to embodiments, the first blank data voltages may be output to the plurality of data lines DL in the blank period of the first frame period in which the data compensation operation is performed, and the second blank data voltages higher than the first blank data voltages may be output to the plurality of data lines DL in the blank period of the second frame period in which the initialization compensation operation is performed. Thus, as described below with reference to FIGS. 11A and 11B, the luminance deviation (or the luminance change) caused by the change of the variable frame frequency VF may be further reduced.

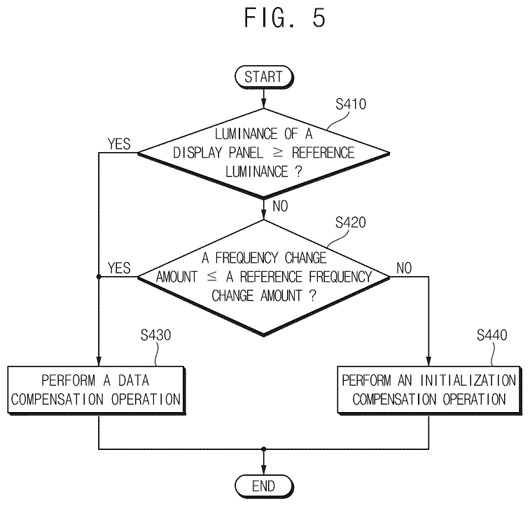

FIG. 5 is a flowchart illustrating a method of operating a display device according to embodiments, FIG. 6A is a diagram illustrating examples of data voltages according to a gray level at a minimum frame frequency and a maximum frame frequency in a case where a data compensation operation is performed, FIG. 6B is a signal timing diagram for describing an example of the data compensation operation, FIG. 6C is a diagram illustrating an example of a luminance according to a variable frame frequency in the case where the data compensation operation is performed, FIG. 7A is a signal timing diagram for describing an example of an initialization compensation operation, FIG. 7B is a diagram illustrating an example of luminances at different frame frequencies in a case where the initialization compensation operation is performed, FIG. 7C is a signal timing diagram for describing another example of the initialization compensation operation, FIG. 7D is a diagram illustrating an example of a luminance according to a variable frame frequency in the case where the initialization compensation operation is performed, and FIG. 8 is a diagram illustrating examples of luminance deviations according to a variable frame frequency with respect to a first luminance and a second luminance in a case where a data compensation operation is performed and a case where an initialization compensation operation is performed.

Referring to FIGS. 1, 4 and 5, in an embodiment, a method of operating a display device, when the luminance DPL of the display panel 110 is greater than or equal to the reference luminance (S410: YES) or when the frequency change amount FCA of the variable frame frequency VF is less than or equal to the reference frequency change amount (S420: YES), the panel driver 120 may perform the data compensation operation (S430). In an embodiment, for example, the display luminance determining block 152 may determine the luminance DPL of the display panel 110 based on the input image data IDAT, the frequency change amount determining block 154 may determine the frequency change amount FCA of the variable frame frequency VF based on the vertical synchronization signal VSYNC, and the compensation operation selecting block 156 may select the data compensation operation when the luminance DPL of the display panel 110 is greater than or equal to the reference luminance or when the frequency change amount FCA of the variable frame frequency VF is less than or equal to the reference frequency change amount.

To perform the data compensation operation, the panel driver 120 may decrease the voltage levels of the data voltages VDAT as the variable frame frequency VF decreases. In an embodiment, for example, as illustrated in FIG. 6A, when the variable frame frequency VF decreases from the maximum frame frequency MAX_VF to the minimum frame frequency MIN_VF, a curve of the data voltage VDAT corresponding to gray levels including the minimum gray level MIN_G (e.g., a 0-gray level 0 G) through the maximum gray level MAX_G (e.g., a 255-gray level 255 G) may be decreased from a first curve 510 corresponding to the maximum frame frequency MAX_VF to a second curve 530 corresponding to the minimum frame frequency MIN_VF.

In an embodiment, for example, as illustrated in FIG. 6B, in a case where the display panel 110 includes first through M-th pixel rows, where M is an integer greater than 1, the scan driver 130 may sequentially provide the first scan signals SC1 through SCM and the second scan signals SS1 through SSM to the first through M-th pixel rows in an active period AP1, AP2 and AP3 of each frame period FP1, FP2 and FP3. When the first scan signal SCN and the second scan signal SSN are provided an the N-th pixel row among the first through M-th pixel rows, where N is an integer greater than or equal to 1 and less than or equal to M, the light emitting elements of the pixels PX in the N-th pixel row may be initialized or turned off, and a luminance L@PXRN of the N-th pixel row may be decreased. Further, in a case where the variable frame frequency VF of first and third frame periods FP1 and FP3 is about 240 Hz and the variable frame frequency VF of a second frame period FP2 is about 120 Hz lower than the variable frame frequency VF of first and third frame periods FP1 and FP3, even if the input image data IDAT represent the same gray level, the data driver 140 may provide first data voltages VDAT1 to the plurality of pixels PX in the active periods AP1 and AP3 of the first and third frame periods FP1 and FP3, but may provide second data voltages VDAT2 lower than the first data voltages VDAT1 to the plurality of pixels PX in the active period AP2 of the second frame period FP2. Accordingly, the luminance L@PXRN of the N-th pixel row may be decreased from when the first and second scan signals SCN and SSN are provided to the N-th pixel row in the active period AP2 of the second frame period FP2 until when the first and second scan signals SCN and SSN are provided to the N-th pixel row in the active period AP3 of the third frame period FP3. That is, even if a time length of the blank period BP2 of the second frame period FP2 is increased compared with a time length of the blank period BP1 of the first frame period FP1, and the light emitting element of each pixel PX is not initialized during the blank period BP2, the luminance increase caused by the increase of the time length of the blank period BP2 may be reduced or compensated. Accordingly, as illustrated in FIG. 6C, the luminance deviation (e.g., the luminance increase rate) caused by the change (e.g., decrease) of the variable frame frequency VF in a luminance 550 of the display device 100 performing the data compensation operation may be reduced compared with the luminance deviation in the luminance 350 of the conventional display device illustrated in FIG. 3C.

When the luminance DPL of the display panel 110 is less than the reference luminance and the frequency change amount FCA of the variable frame frequency VF is greater than the reference frequency change amount (S410: NO & S420: NO), the panel driver 120 may perform the initialization compensation operation (S440). In an embodiment, for example, the compensation operation selecting block 156 may select the initialization compensation operation when the luminance DPL of the display panel 110 determined by the display luminance determining block 152 is less than the reference luminance and the frequency change amount FCA of the variable frame frequency VF determined by the frequency change amount determining block 154 is greater than the reference frequency change amount.

To perform the initialization compensation operation, the panel driver 120 may perform a dummy scan operation in a blank period of a frame period. In an embodiment, for example, as illustrated in FIG. 7A, when the variable frame frequency VF of a fourth frame period FP4 is about 48 Hz and the variable frame frequency VF of a fifth frame period FP5 is about 240 Hz, the scan driver 130 not only may perform an active scan operation ASCAN that sequentially provides the first scan signals SC and the second scan signals SS to the plurality of pixels PX in active periods AP4 and AP5 of the fourth and fifth frame periods FP4 and FP5, but also may periodically perform the dummy scan operation DSCAN that sequentially provides only the second scan signals SS in the blank period BP4 of the fourth frame period FP4. In an embodiment, for example, the scan driver 130 may initiate the dummy scan operation DSCAN after a reference blank time RBT from a start time point of the blank period BP4 of the fourth frame period FP4, and may repeatedly initiate the dummy scan operation DSCAN after the reference blank time RBT from an end time point of the dummy scan operation DSCAN until the fifth frame period FP5 starts. Since the first scan signal SC is not applied to each pixel PX and only the second scan signal SS is applied to each pixel PX while the dummy scan operation DSCAN is performed, the data voltage VDAT stored in each pixel PX may be maintained, and the light emitting element of each pixel PX may be initialized or turned off. Accordingly, as illustrated in FIG. 7B, during a same time period, the number of times the light emitting element of each pixel PX is turned off at the variable frame frequency VF of about 48 Hz may be substantially the same as the number of times the light emitting element of each pixel PX is turned off at the variable frame frequency VF of about 240 Hz. Thus, in a case where the initialization compensation operation is performed, a luminance 610 of the display device 100 at the variable frame frequency VF of about 48 Hz may be substantially the same as a luminance 630 of the display device 100 at the variable frame frequency VF of about 240 Hz.

However, in the case where the initialization compensation operation is performed, if the variable frame frequency VF is not a frequency determined by dividing the maximum frame frequency MAX_VF by a natural number, the dummy scan operation DSCAN in a current frame period may overlap the active scan operation ASCAN in the next frame period, and the luminance of the display device 100 may be reduced compared with the luminance when the variable frame frequency VF is the maximum frame frequency MAX_VF. For example, as illustrated in FIG. 7C, in a case where the variable frame frequency VF of a sixth frame period FP6 is about 100 Hz, an active scan operation ASCAN may be performed in an active period AP6 of the sixth frame period FP6, and a dummy scan operation DSCAN may be performed in a blank period BP6 of the sixth frame period FP6. In this case, the dummy scan operation DSCAN initiated in the blank period BP6 of the sixth frame period FP6 may overlap with the active scan operation ASCAN performed in an active period AP7 of a seventh frame period FP7, and the number of times the light emitting element of each pixel PX is turned off may increase. Thus, as illustrated in FIG. 7D, in a case where the maximum frame frequency MAX_VF is about 240 Hz, the minimum frame frequency MIN_VF is about 48 Hz, and the variable frame frequency VF is not about 240 Hz, about 120 Hz, about 80 Hz, about 60 Hz and about 48 Hz, the luminance of the display device 100 may be reduced compared with the luminance when the variable frame frequency VF is the maximum frame frequency MAX_VF. However, this luminance deviation caused by the change of the variable frame frequency VF in a luminance 650 of the display device 100 performing the initialization compensation operation may be reduced compared with the deviation in the luminance 350 of the conventional display device illustrated in FIG. 3C.

FIG. 8 illustrates a luminance deviation 552 according to the change of the variable frame frequency VF when the data compensation operation is performed and a luminance deviation 652 according to the change of the variable frame frequency VF when the initialization compensation operation is performed in a case where the display panel 110 displays an image with a first luminance L1 at the maximum frame frequency MAX_VF, and also illustrates a luminance deviation 554 according to the change of the variable frame frequency VF when the data compensation operation is performed and a luminance deviation 654 according to the change of the variable frame frequency VF when the initialization compensation operation is performed in a case where the display panel 110 displays an image with a second luminance L2 higher than the first luminance L1 at the maximum frame frequency MAX_VF. As illustrated in FIG. 8, in the case where the display panel 110 displays the image with the relatively high second luminance L2, the luminance deviation 554 according to the change of the variable frame frequency VF when the data compensation operation is performed may be less than the luminance deviation 654 according to the change of the variable frame frequency VF when the initialization compensation operation is performed. Accordingly, in the display device 100 according to embodiments, when the luminance DPL of the display panel 110 is greater than or equal to the reference luminance (S410: YES), the panel driver 120 may perform the data compensation operation S430, thereby reducing or minimizing the luminance deviation caused by the change of the variable frame frequency VF.

Further, when the display panel 110 displays the image with the relatively low first luminance L1 and the variable frame frequency VF is changed from the maximum frame frequency MAX_VF to a first frame frequency VF1 by a relatively small first frequency change amount FCA1, the first luminance deviation ΔL1 caused by the change of the variable frame frequency VF when the data compensation operation is performed may be less than the second luminance deviation ΔL2 caused by the change of the variable frame frequency VF when the initialization compensation operation is performed. Further, when the display panel 110 displays the image with the relatively low first luminance L1 and the variable frame frequency VF is changed by a relatively large second frequency change amount FCA2 from the maximum frame frequency MAX_VF to a second frame frequency VF2, the third luminance deviation ΔL3 caused by the change of the variable frame frequency VF when the data compensation operation is performed may be greater than the fourth luminance deviation ΔL4 caused by the change of the variable frame frequency VF when the initialization compensation operation is performed. Accordingly, in the display device 100 according to embodiments, if the luminance DPL of the display panel 110 is less than the reference luminance and the frequency change amount FCA of the variable frame frequency VF is less than or equal to the reference frequency change amount (S410: NO & S420: YES), the panel driver 120 may perform the data compensation operation (S430), but if the luminance DPL of the display panel 110 is less than the reference luminance and the frequency change amount FCA of the variable frame frequency VF is greater than the reference frequency change amount (S410: NO & S420: NO), the panel driver 120 may perform the initialization compensation operation (S440). Accordingly, in the display device 100 according to embodiments, the luminance deviation caused by the change of the variable frame frequency VF may be reduced or minimized.

FIG. 9 is a flowchart illustrating a method of operating a display device according to embodiments, FIG. 10 is a signal timing diagram for describing a first blank data voltage that is output in a first blank period of a first frame period in which a data compensation operation is performed and a second blank data voltage that is output in a second blank period of a second frame period in which an initialization compensation operation is performed, FIG. 11A is a diagram illustrating an example of a luminance according to a variable frame frequency in a case where a data compensation operation is performed, and FIG. 11B is a diagram illustrating an example of a luminance according to a variable frame frequency in a case where an initialization compensation operation is performed.

Referring to FIGS. 1 and 9, in an embodiment of a method of operating a display device, when the luminance DPL of the display panel 110 is greater than or equal to the reference luminance (S410: YES) or when the frequency change amount FCA of the variable frame frequency VF is less than or equal to the reference frequency change amount (S420: YES), the panel driver 120 may perform a data compensation operation (S430), and may output first blank data voltages to the plurality of data lines DL of the display panel 110 in a blank period of each frame period (S450).

In an embodiment, for example, as illustrated in FIG. 10, in a blank period BP1 of a first frame period FP1 in which the data compensation operation is performed, the data driver 140 may output the first blank data voltages VBLK1 to the plurality of data lines DL. In some embodiments, the first blank data voltages VBLK1 may be the lowest voltage that can be output by the data driver 140. In an embodiment, for example, the first blank data voltages VBLK1 may be the minimum data voltage VDAT_0G corresponding to the minimum gray level (e.g., a 0-gray level), or may be a voltage lower than the minimum data voltage VDAT_0G corresponding to the minimum gray level. When the first blank data voltages VBLK1 are output in the blank period BP1, voltages of the plurality of data lines DL may decreased from the data voltages VDAT in an active period AP1 to the first blank data voltages VBLK1, the first power supply voltage (e.g., the high power supply voltage) provided to the plurality of pixels PX may be decreased by the decrease of the voltages of the plurality of data lines DL (e.g., due to coupling between a line which transfers the first power supply voltage and the plurality of data lines DL), and a second luminance L2 of the display device 100 in the blank period BP1 may be reduced compared with a first luminance L1 of the display device 100 in the active period AP1. Further, as the variable frame frequency VF decreases, a time length of the blank period BP1 in which the display device 100 has the relatively low second luminance L2 increases. Thus, as illustrated in FIG. 11a, the luminance deviation (e.g., the luminance increase) caused by the change (e.g., decrease) of the variable frame frequency VF in the luminance 570 of the display device 100 in the case where the first blank data voltages VBLK1 are output in the blank period BP1 may be further reduced compared with the luminance deviation in the luminance 550 of the display device 100 illustrated in FIG. 6C.

Referring back to FIG. 9, in an embodiment of a method of operating a display device, when the luminance DPL of the display panel 110 is less than the reference luminance and the frequency change amount FCA of the variable frame frequency VF is greater than the reference frequency change amount (S410: NO & S420: NO), the panel driver 120 may perform the initialization compensation operation (S440), and may output second blank data voltages higher than the first blank data voltages to the plurality of data lines DL of the display panel 110 in the blank period of each frame period (S460).

In an embodiment, for example, as illustrated in FIG. 10, in a blank period BP2 of a second frame period FP2 in which the initialization compensation operation is performed, the data driver 140 may output the second blank data voltages VBLK2 higher than the first blank data voltages VBLK1 to the plurality of data lines DL. In some embodiments, the second blank data voltages VBLK2 may be the data voltages VDAT that were provided to the plurality of pixels PX in an active period AP2 of the second frame period FP2. In an embodiment, for example, the second blank data voltages VBLK2 may be the data voltages VDAT that were provided to the last pixel row of the display panel 110 in the active period AP2 of the second frame period FP2. In such an embodiment, the luminance of the display device 100 in the blank period BP2 may be substantially equal to the first luminance L1 of the display device 100 in the active period AP2. In other embodiments, the second blank data voltages VBLK2 may be boosted voltages BVDAT that are increased from the data voltages VDAT provided to the plurality of pixels PX in the active period AP2 of the second frame period FP2. In another embodiment, for example, the boosted voltages BVDAT may be increased in proportion to the data voltages VDAT provided to the last pixel row of the display panel 110 in the active period AP2 of the second frame period FP2. In such an embodiment, a third luminance L3 of the display device 100 in the blank period BP2 may be higher than the first luminance L1 of the display device 100 in the active period AP2. In still another embodiment, the second blank data voltages VBLK2 may be the initialization voltage VINT. In such an embodiment, a fourth luminance L4 of the display device 100 in the blank period BP2 may be lower than the first luminance L1 of the display device 100 in the active period AP2, but may be higher than the second luminance L2 corresponding to the first blank data voltages VBLK1. Accordingly, as illustrated in FIG. 11B, the luminance deviation caused by the change of the variable frame frequency VF in the luminance 670 of the display device 100 in the case where the second blank data voltages VBLK2 are output in the blank period BP2 may be further reduced compared with the luminance deviation in the luminance 650 of the display device 100 illustrated in FIG. 7D.

As described above, in the display device 100 according to embodiments, the first blank data voltages VBLK1 may be output in the blank period BP1 of the first frame period FP1 in which the data compensation operation is performed, and the second blank data voltages VBLK2 higher than the first blank data voltages VBLK1 may be output in the blank period BP2 of the second frame period FP2 in which the initialization compensation operation is performed. Accordingly, the luminance deviation caused by the change of the variable frame frequency VF may be further reduced.

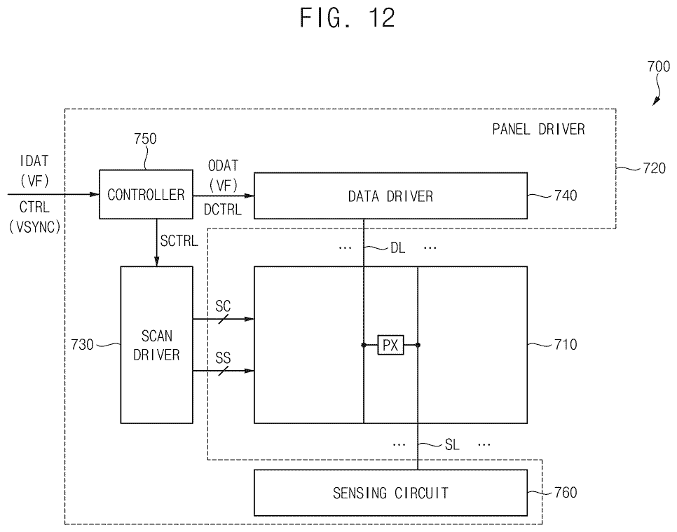

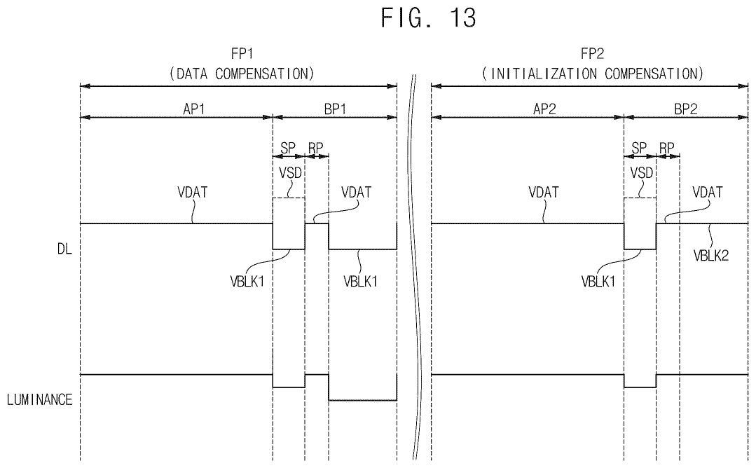

FIG. 12 is a block diagram illustrating a display device according to embodiments, and FIG. 13 is a signal timing diagram for describing a first blank data voltage that is output in a first blank period of a first frame period in which a data compensation operation is performed and a second blank data voltage that is output in a second blank period of a second frame period in which an initialization compensation operation is performed.

Referring to FIG. 12, a display device 700 according to embodiments may include a display panel 710 that includes a plurality of pixels PX, and a panel driver 720 that drives the display panel 710. The panel driver 720 may include a scan driver 730, a data driver 740, a controller 750, and a sensing circuit 760 connected to the plurality of pixels PX through a plurality of sensing lines SL. The display device 700 of FIG. 12 may be substantially the same as the display device 100 of FIG. 1, except that the panel driver 720 may further include the sensing circuit 760.

The sensing circuit 760 may perform a sensing operation on selected pixels among the plurality of pixels PX through the plurality of sensing lines SL in a sensing period within a blank period of each frame period. In an embodiment, for example, the display panel 710 may include a plurality of pixel rows, each pixel row including red, green and blue pixels, and the sensing circuit 760 may perform the sensing operation on selected color pixels among the red, green and blue pixels in a selected pixel row among the plurality of pixel rows in each sensing period. In some embodiments, the data driver 740 and the sensing circuit 760 may be implemented as, but not limited to, a single integrated circuit, and the single integrated circuit of the data driver 740 and the sensing circuit 760 may be referred to as a readout source driver integrated circuit (“RSIC”).

The panel driver 720 of the display device 700 according to embodiments may selectively perform a data compensation operation or an initialization compensation operation. In a blank period of a first frame period in which the data compensation operation is performed, the panel driver 720 may perform the sensing operation and a recovery operation, and may output first blank data voltages to a plurality of data lines DL. Further, in a blank period of a second frame period in which the initialization compensation operation is performed, the panel driver 720 may perform the sensing operation and the recovery operation, and may output second blank data voltages higher than the first blank data voltages to the plurality of data lines DL.

In an embodiment, for example, as illustrated in FIG. 13, the blank periods BP1 and BP2 of each frame period FP1 and FP2 may include a sensing period SP in which the sensing operation is performed, and a recovery period RP in which the recovery operation that rewrites the data voltages VDAT to the selected pixel row is performed. In the sensing period SP, the data driver 740 may output sensing data voltage VSD to data lines connected to the selected pixels among the plurality of data lines DL, and may output the first blank data voltages VBLK1 to data lines that are not connected to the selected pixels among the plurality of data lines DL. Since the sensing operation is performed on the selected color pixels among the red, green and blue pixels, the sensing data voltage VSD may be applied to about ⅓ of the plurality of data lines DL, and the first blank data voltages VBLK1 may be applied to about ⅔ of the plurality of data lines DL. Thus, in the sensing period SP in which the sensing operation is performed, a luminance of the display device 700 may be reduced. Further, in the recovery period RP, the data driver 740 may output recovery data voltages substantially equal to the data voltages VDAT that were provided in the active period AP1 and AP2 to the plurality of data lines DL, and the recovery data voltages, or the data voltages VDAT may be rewritten to the pixels PX in the selected pixel row.

Further, within the blank period BP1 of the first frame period FP1 in which the data compensation operation is performed, after the recovery period RP, the data driver 740 may output the first blank data voltages VBLK1 to the plurality of data lines DL. In an embodiment, for example, the first blank data voltages VBLK1 may be a minimum data voltage corresponding to a minimum gray level, or a voltage lower than the minimum data voltage. Further, within the blank period BP2 of the second frame period FP2 in which the initialization compensation operation is performed, after the recovery period RP, the data driver 740 may output the second blank data voltages VBLK2 higher than the first blank data voltages VBLK1 to the plurality of data lines DL. In some embodiments, the second blank data voltages VBLK2 may be the recovery data voltages (or the data voltages VDAT) that were provided to the selected pixel row in the recovery period RP of the second frame period FP2. In other embodiments, the second blank data voltages VBLK2 may be boosted voltages that are increased from the recovery data voltages (or the data voltages VDAT) provided to the selected pixel row in the recovery period RP of the second frame period FP2. In still other embodiments, the second blank data voltages VBLK2 may be an initialization voltage.

As described above, in the display device 700 according to embodiments, the data compensation operation or the initialization compensation operation may be selectively performed. Accordingly, the luminance deviation caused by the change of the variable frame frequency VF may be reduced. Further, in the display device 700 according to embodiments, the first blank data voltages VBLK1 may be output to the plurality of data lines DL in the blank period BP1 of the first frame period FP1 in which the data compensation operation is performed, and the second blank data voltages VBLK2 higher than the first blank data voltages VBLK1 may be output to the plurality of data lines DL in the blank period BP2 of the second frame period FP2 in which the initialization compensation operation is performed. Accordingly, the luminance deviation caused by the change of the variable frame frequency VF may be further reduced.

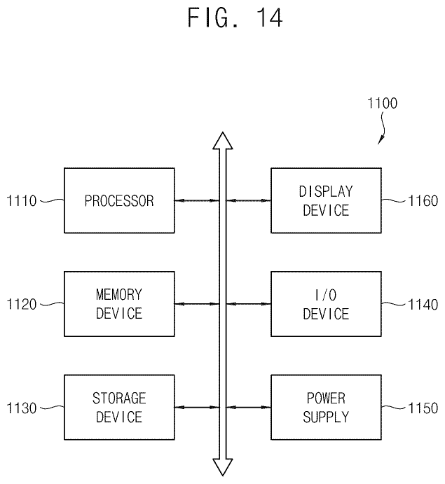

FIG. 14 is a block diagram illustrating an electronic device including a display device according to embodiments.

Referring to FIG. 14, an embodiment of an electronic device 1100 may include a processor 1110, a memory device 1120, a storage device 1130, an input/output (“I/O”) device 1140, a power supply 1150 and a display device 1160. The electronic device 1100 may further include a plurality of ports for communicating with a video card, a sound card, a memory card, a universal serial bus (“USB”) device, other electric devices, etc.

The processor 1110 may perform various computing functions or tasks. The processor 1110 may be an application processor (“AP”), a micro-processor, a central processing unit (“CPU”), etc. The processor 1110 may be coupled to other components via an address bus, a control bus, a data bus, etc. Further, in some embodiments, the processor 1110 may be further coupled to an extended bus such as a peripheral component interconnection (“PCI”) bus.

The memory device 1120 may store data for operations of the electronic device 1100. In an embodiment, for example, the memory device 1120 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or at least one volatile memory device such as a dynamic random access memory (“DRAM”) device, a static random access memory (“SRAM”) device, a mobile dynamic random access memory (“mobile DRAM”) device, etc.

The storage device 1130 may be a solid state drive (“SSD”) device, a hard disk drive (“HDD”) device, a compact disc-read only memory (“CD-ROM”) device, etc. The I/O device 1140 may be an input device such as a keyboard, a keypad, a mouse, a touch screen, etc., and an output device such as a printer, a speaker, etc. The power supply 1150 may supply power for operations of the electronic device 1100. The display device 1160 may be coupled to other components through the buses or other communication links.

In such an embodiment, the display device 1160 may correspond to the embodiments of the display device described above. In the display device 1160, in a variable frame mode, a data compensation operation or an initialization compensation operation may be selectively performed according to a luminance of a display panel and a frequency change amount of a variable frame frequency. Accordingly, a luminance deviation caused by a frame frequency change may be reduced. Further, in the display device 1160, first blank data voltages may be output in a blank period of a first frame period in which the data compensation operation is performed, and second blank data voltages, which are different from (e.g., higher than) the first blank data voltages, may be output in a blank period of a second frame period in which the initialization compensation operation is performed. Accordingly, the luminance deviation caused by the frame frequency change may be further reduced.

Embodiments of the disclosure may be applied any electronic device 1100 including the display device 1160, for example, a mobile phone, a smart phone, a virtual reality (“VR”) device, a television (“TV”) (e.g., a digital TV, a three-dimensional (“3D”) TV, etc.), a wearable electronic device, a personal computer (“PC”) (e.g. a laptop computer, a tablet computer, etc.), a home appliance, a personal digital assistant (“PDA”), a portable multimedia player (“PMP”), a digital camera, a music player, a portable game console, a navigation device, etc.

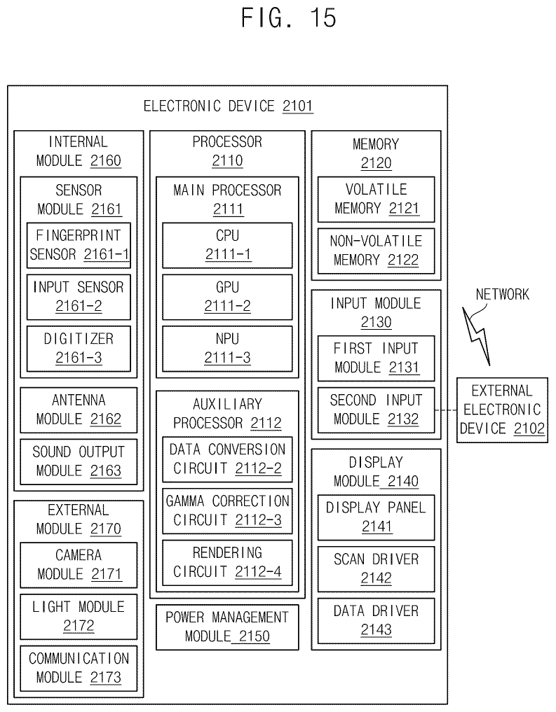

FIG. 15 is a block diagram illustrating an example of an electronic device according to embodiments.

An embodiment of the electronic device 2101 may output various information via a display module 2140 in an operating system. When a processor 2110 executes an application stored in a memory 2120, the display module 2140 may provide application information to a user via a display panel 2141.

The processor 2110 may obtain an external input via an input module 2130 or a sensor module 2161 and may execute an application corresponding to the external input. For example, when the user selects a camera icon displayed on the display panel 2141, the processor 2110 may obtain a user input via an input sensor 2161-2 and may activate a camera module 2171. The processor 2110 may transfer image data corresponding to an image captured by the camera module 2171 to the display module 2140. The display module 2140 may display an image corresponding to the captured image via the display panel 2141.

For example, when personal information authentication is executed in the display module 2140, a fingerprint sensor 2161-1 may obtain input fingerprint information as input data. The processor 2110 may compare the input data obtained by the fingerprint sensor 2161-1 with authentication data stored in the memory 2120, and may execute an application according to the comparison result. The display module 2140 may display information executed according to application logic via the display panel 2141.

For example, when a music streaming icon displayed on the display module 2140 is selected, the processor 2110 obtains a user input via the input sensor 2161-2 and may activate a music streaming application stored in the memory 2120. When a music execution command is input in the music streaming application, the processor 2110 may activate a sound output module 2163 to provide sound information corresponding to the music execution command to the user.

In the above, an operation of the electronic device 2101 has been briefly described. Hereinafter, a configuration of the electronic device 2101 will be described in detail. Some components of the electronic device 2101 described below may be integrated and provided as one component, or one component may be provided separately as two or more components.

Referring to FIG. 15, the electronic device 2101 may communicate with an external electronic device 2102 via a network (e.g., a short-range wireless communication network or a long-range wireless communication network). In some embodiments, the electronic device 2101 may include the processor 2110, the memory 2120, the input module 2130, the display module 2140, a power management module 2150, an internal module 2160 and an external module 2170. In some embodiments, at least one of the components may be omitted from the electronic device 2101, or one or more other components may be added in the electronic device 2101. In some embodiments, some of the components (e.g., the sensor module 2161, an antenna module 2162, or the sound output module 2163) may be implemented as a single component (e.g., the display module 2140).

The processor 2110 may execute software to control at least one other component (e.g., a hardware or software component) of the electronic device 2101 coupled with the processor 2110, and may perform various data processing or computation. According to some embodiments, as at least part of the data processing or computation, the processor 2110 may store a command or data received from another component (e.g., the input module 2130, the sensor module 2161 or a communication module 2173) in a volatile memory 2121, may process the command or the data stored in the volatile memory 2121, and may store resulting data in a non-volatile memory 2122.

The processor 2110 may include a main processor 2111 and an auxiliary processor 2112. The main processor 2111 may include one or more of a central processing unit (CPU) 2111-1 or an application processor (AP). The main processor 2111 may further include any one or more of a graphics processing unit (GPU) 2111-2, a communication processor (CP), and an image signal processor (ISP). The main processor 2111 may further include a neural processing unit (NPU) 2111-3. The NPU 2111-3 may be a processor specialized in processing an artificial intelligence model, and the artificial intelligence model may be generated through machine learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof, but is not limited thereto. The artificial intelligence model may, additionally or alternatively, include a software structure other than a hardware structure. At least two of the above-described processing units and processors may be implemented as an integrated component (e.g., a single chip), or respective processing units and processors may be implemented as independent components (e.g., a plurality of chips).

The auxiliary processor 2112 may include a controller. The controller included in the auxiliary processor 2112 may correspond to a controller 150 illustrated in FIG. 1 or a controller 750 illustrated in FIG. 12. The controller may include an interface conversion circuit and a timing control circuit. The controller may receive an image signal from the main processor 2111, may convert a data format of the image signal to meet interface specifications with the display module 2140, and may output image data. The controller may output various control signals required for driving the display module 2140. The controller may receive the image signal (or input image date) from the main processor 2111 at a variable frame frequency, and may selectively perform a data compensation operation or an initialization compensation operation. Accordingly, a luminance deviation caused by a chance of the variable frame frequency may be reduced.

The auxiliary processor 2112 may further include a data conversion circuit 2112-2, a gamma correction circuit 2112-3, a rendering circuit 2112-4, or the like. The data conversion circuit 2112-2 may receive image data from the controller. The data conversion circuit 2112-2 may compensate for the image data such that an image is displayed with a desired luminance according to characteristics of the electronic device 2101 or the user's setting, or may convert the image data to reduce power consumption or to eliminate an afterimage. The gamma correction circuit 2112-3 may convert image data or a gamma reference voltage so that an image displayed on the electronic device 2101 has desired gamma characteristics. The rendering circuit 2112-4 may receive image data from the controller, and may render the image data in consideration of a pixel arrangement of the display panel 2141 in the electronic device 2101. At least one selected from the data conversion circuit 2112-2, the gamma correction circuit 2112-3 and the rendering circuit 2112-4 may be integrated in another component (e.g., the main processor 2111 or the controller). At least one selected from the data conversion circuit 2112-2, the gamma correction circuit 2112-3 and the rendering circuit 2112-4 may be integrated in a data driver 2143 described below.

The memory 2120 may store various data used by at least one component (e.g., the processor 2110 or the sensor module 2161) of the electronic device 2101. The various data may include, for example, input data or output data for a command related thereto. The memory 2120 may include at least one selected from the volatile memory 2121 and the non-volatile memory 2122.

The input module 2130 may receive a command or data to be used by the components (e.g., the processor 2110, the sensor module 2161, or the sound output module 2163) of the electronic device 2101 from the outside of the electronic device 2101 (e.g., the user or the external electronic device 2102).

The input module 2130 may include a first input module 2131 for receiving a command or data from the user, and a second input module 2132 for receiving a command or data from the external electronic device 2102. The first input module 2131 may include a microphone, a mouse, a keyboard, a key (e.g., a button) or a pen (e.g., a passive pen or an active pen). The second input module 2132 may support a designated protocol capable of connecting the electronic device 2101 to the external electronic device 2102 by wire or wirelessly. In some embodiments, the second input module 2132 may include a high definition multimedia interface (HDMI), a universal serial bus (USB) interface, an SD card interface or an audio interface. The second input module 2132 may include a connector that may physically connect the electronic device 2101 to the external electronic device 2102. For example, the second input module 2132 may include an HDMI connector, a USB connector, an SD card connector or an audio connector (e.g., a headphone connector).

The display module 2140 may visually provide information to the user. The display module 2140 may include the display panel 2141, a scan driver 2142 and the data driver 2143. The display module 2140 may further include a window, a chassis and a bracket for protecting the display panel 2141.

The display panel 2141 may include a liquid crystal display panel, an organic light emitting display panel or an inorganic light emitting display panel, but the type of the display panel 2141 is not limited thereto. The display panel 2141 may be a rigid type display panel, or a flexible type display panel capable of being rolled or folded. The display module 2140 may further include a supporter, a bracket or a heat dissipation member that supports the display panel 2141.

The scan driver 2142 may be mounted on the display panel 2141 as a driving chip. Alternatively, the scan driver 2142 may be integrated into the display panel 2141. For example, the scan driver 2142 may include an amorphous silicon TFT gate driver circuit (ASG), a low temperature polycrystalline silicon (LTPS) TFT gate driver circuit or an oxide semiconductor TFT gate driver circuit (OSG) embedded in the display panel 2141. The scan driver 2142 may receive a control signal from the controller and may output scan signals to the display panel 2141 in response to the control signal.

The display panel 2141 may further include an emission driver. The emission driver may output an emission control signal to the display panel 2141 in response to a control signal received from the controller. The emission driver may be formed separately from the scan driver 2142, or may be integrated into the scan driver 2142.

The data driver 2143 may receive a control signal from the controller, may convert image data into analog voltages (e.g., data voltages) in response to the control signal, and then may output the data voltages to the display panel 2141. The data driver 2143 may output first blank data voltages in a blank period of a first frame period in which the data compensation operation is performed, and may output second blank data voltages, which are different from (e.g., higher than) the first blank data voltages, in a blank period of a second frame period in which the initialization compensation operation is performed. Accordingly, the luminance deviation caused by the chance of the variable frame frequency may be further reduced.

The data driver 2143 may be incorporated into other components (e.g., the controller). Further, the functions of the interface conversion circuit and the timing control circuit of the controller described above may be integrated into the data driver 2143.

The display module 2140 may further include the emission driver, a voltage generator circuit, or the like. The voltage generator circuit may output various voltages used to drive the display panel 2141.

The power management module 2150 may supply power to the components of the electronic device 2101. The power management module 2150 may include a battery that charges a power supply voltage. The battery may include a primary cell which is not rechargeable, a secondary cell which is rechargeable, or a fuel cell. The power management module 2150 may include a power management integrated circuit (PMIC). The PMIC may supply optimal power to each of the modules described above and modules described below. The power management module 2150 may include a wireless power transmission/reception member electrically connected to the battery. The wireless power transmission/reception member may include a plurality of antenna radiators in the form of coils.

The electronic device 2101 may further include the internal module 2160 and the external module 2170. The internal module 2160 may include the sensor module 2161, the antenna module 2162 and the sound output module 2163. The external module 2170 may include the camera module 2171, a light module 2172 and the communication module 2173.

The sensor module 2161 may detect an input by the user's body or an input by the pen of the first input module 2131, and may generate an electrical signal or data value corresponding to the input. The sensor module 2161 may include at least one selected from the fingerprint sensor 2161-1, the input sensor 2161-2 and a digitizer 2161-3.

The fingerprint sensor 2161-1 may generate a data value corresponding to the user's fingerprint. The fingerprint sensor 2161-1 may include any one of an optical type fingerprint sensor and a capacitive type fingerprint sensor.

The input sensor 2161-2 may generate a data value corresponding to coordinate information of the user's body input or the pen input. The input sensor 2161-2 may convert a capacitance change caused by the input into the data value. The input sensor 2161-2 may detect the input by the passive pen, or may transmit/receive data to/from the active pen.

The input sensor 2161-2 may measure a bio-signal, such as blood pressure, moisture or body fat. In an embodiment, for example, when a portion of the body of the user touches a sensor layer or a sensing panel, and does not move for a certain period of time, the input sensor 2161-2 may output information desired by the user to the display module 2140 by detecting the bio-signal based on a change in electric field due to the portion of the body.

The digitizer 2161-3 may generate a data value corresponding to coordinate information of the input by the pen. The digitizer 2161-3 may convert an amount of an electromagnetic change caused by the input into the data value. The digitizer 2161-3 may detect the input by the passive pen, or may transmit/receive data to/from the active pen.

At least one selected from the fingerprint sensor 2161-1, the input sensor 2161-2 and the digitizer 2161-3 may be implemented as a sensor layer formed on the display panel 2141 through a continuous process. The fingerprint sensor 2161-1, the input sensor 2161-2 and the digitizer 2161-3 may be disposed above the display panel 2141, or at least one selected from the fingerprint sensor 2161-1, the input sensor 2161-2 and the digitizer 2161-3 may be disposed below the display panel 2141.

Two or more selected from the fingerprint sensor 2161-1, the input sensor 2161-2 and the digitizer 2161-3 may be integrated into one sensing panel through the same process. When integrated into one sensing panel, the sensing panel may be disposed between the display panel 2141 and a window disposed above the display panel 2141. In some embodiments, the sensing panel may be disposed on the window, but the location of the sensing panel is not limited thereto.

At least one selected from the fingerprint sensor 2161-1, the input sensor 2161-2 and the digitizer 2161-3 may be embedded in the display panel 2141. In other words, at least one selected from the fingerprint sensor 2161-1, the input sensor 2161-2 and the digitizer 2161-2 may be simultaneously formed through a process of forming elements (e.g., light emitting elements, transistors, etc.) included in the display panel 2141.

In addition, the sensor module 2161 may generate an electrical signal or a data value corresponding to an internal state or an external state of the electronic device 2101. The sensor module 2161 may further include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor or an illuminance sensor.

The antenna module 2162 may include one or more antennas for transmitting or receiving a signal or power to or from the outside. In some embodiments, the communication module 2173 may transmit or receive a signal to or from the external electronic device 2102 through an antenna suitable for a communication method. An antenna pattern of the antenna module 2162 may be integrated into one component (e.g., the display panel 2141) of the display module 2140 or the input sensor 2161-2.

The sound output module 2163 may output sound signals to the outside of the electronic device 2101. The sound output module 2163 may include, for example, a speaker or a receiver. The speaker may be used for general purposes, such as playing multimedia or playing record. The receiver may be used for receiving incoming calls. In some embodiments, the receiver may be implemented as separate from, or as part of the speaker. A sound output pattern of the sound output module 2163 may be integrated into the display module 2140.

The camera module 2171 may capture a still image and a moving image. In some embodiments, the camera module 2171 may include one or more lenses, an image sensor or an image signal processor. The camera module 2171 may further include an infrared camera capable of measuring the presence or absence of the user, the user's location and the user's line of sight.

The light module 2172 may provide light. The light module 2172 may include a light emitting diode or a xenon lamp. The light module 2172 may operate in conjunction with the camera module 2171, or may operate independently of the camera module 2171.

The communication module 2173 may support establishing a wired or wireless communication channel between the electronic device 2101 and the external electronic device 2102 and performing communication via the established communication channel. The communication module 2173 may include a wireless communication module (e.g., a cellular communication module, a short-range wireless communication module or a global navigation satellite system (GNSS) communication module) or a wired communication module (e.g., a local area network (LAN) communication module or a power line communication (PLC) module). The communication module 2173 may communicate with the external electronic device 2102 via a short-range communication network (e.g., Bluetooth™, wireless-fidelity (Wi-Fi) direct, or infrared data association (IrDA)) or a long-range communication network (e.g., a cellular network, the Internet or a computer network (e.g., LAN or wide area network (WAN))). These various types of communication modules 2173 may be implemented as a single chip, or may be implemented as multi-chips separate from each other.

The input module 2130, the sensor module 2161, the camera module 2171, and the like may be used to control an operation of the display module 2140 in conjunction with the processor 2110.

The processor 2110 may output a command or data to the display module 2140, the sound output module 2163, the camera module 2171 or the light module 2172 based on input data received from the input module 2130. In an embodiment, for example, the processor 2110 may generate image data corresponding to input data applied through a mouse or an active pen, and may output the image data to the display module 2140. Alternatively, the processor 2110 may generate command data corresponding to the input data, and may output the command data to the camera module 2171 or the light module 2172. When no input data is received from the input module 2130 for a certain period of time, the processor 2110 may switch an operation mode of the electronic device 2101 to a low power mode or a sleep mode, thereby reducing power consumption of the electronic device 2101.

The processor 2110 may output a command or data to the display module 2140, the sound output module 2163, the camera module 2171 or the light module 2172 based on sensing data received from the sensor module 2161. In an embodiment, for example, the processor 2110 may compare authentication data applied by the fingerprint sensor 2161-1 with authentication data stored in the memory 2120, and then may execute an application according to the comparison result. The processor 2110 may execute a command or output corresponding image data to the display module 2140 based on the sensing data sensed by the input sensor 2161-2 or the digitizer 2161-3. In a case where the sensor module 2161 includes a temperature sensor, the processor 2110 may receive temperature data from the sensor module 2161, and may further perform luminance correction on the image data based on the temperature data.

The processor 2110 may receive measurement data about the presence or absence of the user, the location of the user and the user's line of sight from the camera module 2171. The processor 2110 may further perform luminance correction on the image data based on the measurement data. In an embodiment, for example, after the processor 2110 determines the presence or absence of the user based on the input from the camera module 2171, the data conversion circuit 2112-2 or the gamma correction circuit 2112-3 may perform the luminance correction on the image data, and the processor 2110 may provide the luminance-corrected image data to the display module 2140.

At least one or more of the above-described components may be coupled mutually and communicate signals (e.g., commands or data) therebetween via an inter-peripheral communication scheme (e.g., a bus, general purpose input and output (GPIO), serial peripheral interface (SPI), mobile industry processor interface (MIPI) or ultra-path interconnect (UPI)). The processor 2110 may communicate with the display module 2140 via an agreed interface. Further, any one of the above-described communication methods may be used between the processor 2110 and the display module 2140, but the communication method between the processor 2110 and the display module 2140 is not limited to the above-described communication method.

The electronic device 2101 according to various embodiments described above may be various types of devices. In an embodiment, for example, the electronic device 2101 may include at least one selected from a portable communication device (e.g., a smart phone), a computer device, a portable multimedia device, a portable medical device, a camera, a wearable device and a home appliance. However, the electronic device 2101 according to embodiments is not limited to the above-described devices.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including a plurality of pixels; and
a panel driver which drives the display panel based on input image data,
wherein, in a variable frame mode in which the panel driver receives the input image data at a variable frame frequency, the panel driver selectively performs a data compensation operation or an initialization compensation operation based on a luminance of the display panel and a frequency change amount of the variable frame frequency.

2. The display device of claim 1, wherein, the panel driver performs the data compensation operation by adjusting voltage levels of data voltages provided to the plurality of pixels in an active period of a frame period corresponding to the variable frame frequency.

3. The display device of claim 2, wherein, as the variable frame frequency decreases, the panel driver decreases the voltage levels of the data voltages.

4. The display device of claim 1, wherein, the panel driver performs the initialization compensation operation by performing a dummy scan operation for initializing light emitting elements of the plurality of pixels in a blank period of a frame period.

5. The display device of claim 1, wherein the panel driver performs the data compensation operation when the luminance of the display panel is greater than or equal to a reference luminance or the frequency change amount of the variable frame frequency is less than or equal to a reference frequency change amount, and
wherein the panel driver performs the initialization compensation operation when the luminance of the display panel is less than the reference luminance and the frequency change amount of the variable frame frequency is greater than the reference frequency change amount.

6. The display device of claim 1, wherein the panel driver outputs first blank data voltages in a blank period of a first frame period in which the data compensation operation is performed, and outputs second blank data voltages, which are different from the first blank data voltages, in a blank period of a second frame period in which the initialization compensation operation is performed.

7. The display device of claim 6, wherein the second blank data voltages are higher than the first blank data voltages.

8. The display device of claim 1, wherein the panel driver includes:
a scan driver which provides first scan signals and second scan signals to the plurality of pixels in an active period of a frame period;
a data driver which provides data voltages to the plurality of pixels in the active period; and
a controller which controls the scan driver and the data driver, and
wherein the controller includes:
a display luminance determining block which determines the luminance of the display panel based on the input image data;
a frequency change amount determining block which determines the frequency change amount of the variable frame frequency based on a vertical synchronization signal; and
a compensation operation selecting block which select the data compensation operation or the initialization compensation operation based on the luminance of the display panel and the frequency change amount of the variable frame frequency.

9. The display device of claim 8, wherein the compensation operation selecting block selects the data compensation operation when the luminance of the display panel is greater than or equal to a reference luminance or the frequency change amount of the variable frame frequency is less than or equal to a reference frequency change amount, and
wherein the compensation operation selecting block selects the initialization compensation operation when the luminance of the display panel is less than the reference luminance and the frequency change amount of the variable frame frequency is greater than the reference frequency change amount.

10. The display device of claim 8, wherein, when the compensation operation selecting block selects the data compensation operation, the data driver decreases voltage levels of the data voltages as the variable frame frequency decreases.

11. The display device of claim 8, wherein, when the compensation operation selecting block selects the initialization compensation operation, the scan driver performs a dummy scan operation by sequentially providing the second scan signals to the plurality of pixels in a blank period of the frame period.

12. The display device of claim 8, wherein, in a blank period of a first frame period in which the compensation operation selecting block selects the data compensation operation, the data driver outputs first blank data voltages to a plurality of data lines of the display panel, and
wherein, in a blank period of a second frame period in which the compensation operation selecting block selects the initialization compensation operation, the data driver outputs second blank data voltages, which are different from the first blank data voltages, to the plurality of data lines.

13. The display device of claim 12, wherein the first blank data voltages are minimum data voltages corresponding to a minimum gray level.

14. The display device of claim 12, wherein the first blank data voltages are lower than a minimum data voltage corresponding to a minimum gray level.

15. The display device of claim 12, wherein the second blank data voltages are equal to the data voltages provided to a last pixel row of the display panel in an active period of the second frame period.

16. The display device of claim 12, wherein the second blank data voltages are boosted voltages which are increased from the data voltages provided to a last pixel row of the display panel in an active period of the second frame period.

17. The display device of claim 12, wherein the second blank data voltages are an initialization voltage.

18. The display device of claim 8, wherein a blank period of the frame period includes a sensing period and a recovery period,
wherein the panel driver further includes:
a sensing circuit which performs a sensing operation on selected pixels among the plurality of pixels in the sensing period,
wherein, in the sensing period, the data driver outputs sensing data voltages to data lines which are connected to the selected pixels among a plurality of data lines of the display panel, and outputs first blank data voltages to data lines which are not connected to the selected pixels among the plurality of data lines, and
wherein, in the recovery period, the data driver outputs recovery data voltages equal to the data voltages provided in the active period to the plurality of data lines.

19. A display device comprising:
a display panel including a plurality of pixels; and
a panel driver which drives the display panel based on input image data,
wherein, in a variable frame mode in which the panel driver receives the input image data at a variable frame frequency, the panel driver selectively performs a data compensation operation or an initialization compensation operation based on a luminance of the display panel and a frequency change amount of the variable frame frequency, and
wherein the panel driver outputs first blank data voltages in a blank period of a first frame period in which the data compensation operation is performed, and outputs second blank data voltages, which are different from the first blank data voltages, in a blank period of a second frame period in which the initialization compensation operation is performed.

20. An electronic device comprising:
a processor which provides input image data at a variable frame frequency in a variable frame mode; and
a display device comprising:
a display panel including a plurality of pixels; and
a panel driver which drives the display panel based on the input image data,
wherein, in the variable frame mode, the panel driver selectively performs a data compensation operation or an initialization compensation operation based on a luminance of the display panel and a frequency change amount of the variable frame frequency.
